(19) United States
(12) Patent Application Publication
(10) Pub. No.: US 2004/0247939 A1
(43) Pub. Date: Dec. 9, 2004

(54) Composite magnetic material and manufacturing method thereof

(75) Inventor: Haruhisa Toyoda, Itami-shi (JP)

Correspondence Address: McDERMOTT, WILL & EMERY, 600 13th Street, N.W., Washington, DC, 20005-3096, US

(73) Assignee: SUMITOMO ELECTRIC INDUSTRIES, LTD.

(21) Appl. No.: 10/857,008

(22) Filed: Jun. 1, 2004

(30) Foreign Application Priority Data
Jun. 3, 2003 (JP) 158024/2003

(51) Int. Cl. B32B 27/02

(52) U.S. Cl. 428/692; 428/402; 148/237

(57) ABSTRACT

A composite magnetic material having excellent magnetic characteristics and a manufacturing method thereof are provided, without requiring complex processes such as a process of flattening a soft magnetic material or controlling an oxygen concentration and without equipment costs of a magnetic field applying apparatus, etc. The composite magnetic material according to the present invention comprises multiple composite magnetic particles having metal magnetic particles and insulating films surrounding the metal magnetic particles; the multiple composite magnetic particles are bonded to each other, and the metal magnetic particles comprise only the metal magnetic material and impurities with the mass ratio to the metal magnetic particle of 120 ppm or less.

### BACKGROUND OF THE INVENTION

1. Field of the Invention

The present invention relates to a composite magnetic material and a manufacturing method thereof, and more specifically to a composite magnetic material having metal magnetic particles and insulating films, and a manufacturing method thereof.

2. Description of the Background Art

Recently, an increase in density and a decrease in size of electrical and electronic components have been accomplished, and further accurate controls capable of performance with small power in motor cores, transformer cores, etc has been required. For this reason, composite magnetic materials having excellent magnetic characteristics in intermediate and high frequency ranges have been developed as composite magnetic materials used in electrical and electronic components. The composite magnetic materials should have a high-saturated magnetic flux density, high magnetic permeability, and high electrical resistivity so as to have excellent magnetic characteristics.

A composite soft magnetic material as such a composite magnetic material is disclosed for example in Japanese Unexamined Patent Application Publication No. 6-267723. Further, a method of manufacturing a composite magnetic material is disclosed in Japanese Unexamined Patent Application Publication No. 2000-232014.

The composite soft magnetic material disclosed in Japanese Unexamined Patent Application Publication No. 6-267723 has high-resistance soft magnetic material layers interposed between soft magnetic metal particles having a nonmagnetic metal oxide layer on the surface layer thereof, and is characterized by a flat shaped soft magnetic material, the main surface of which is not oriented vertically to the magnetic field applied in use. As a result, the influence of the generated demagnetizing field can be reduced, the improvement of magnetic permeability or decrease of power loss.

In addition, in the method of manufacturing a composite magnetic material disclosed in Japanese Unexamined Patent Application Publication No. 2000-232014, when performing a heat treatment process after pressure-molding of mixtures comprising magnetic powders and insulating matter, the heat treatment process is performed twice or more, and the oxygen concentration of the first heat treatment process is set to be higher than that of the second heat treatment process. As a result, it is possible to securey reduce eddy current loss since the metal surfaces of the magnetic powders in a molded body are oxidized and insulated at the first heat treatment process even in a high-density molding process.

However, in the composite soft magnetic material disclosed in Japanese Unexamined Patent Application Publication No. 6-267723, it is necessary to flatten the soft magnetic material. Therefore, a step of flattening normal atomized powders and reduced powders is required, which may cause a problem of complicating the manufacturing method. Furthermore, when controlling the orientation of the flattened composite soft magnetic material, a magnetic field applying apparatus must be provided in a press machine, thereby raising costs.

Furthermore, in the method of manufacturing the composite magnetic material disclosed in Japanese Unexamined Patent Application Publication No. 2000-232014, the oxygen concentration is controlled during the heat treatment process. However, from the viewpoint of production technique, it is technically difficult to control the oxygen concentration, and it is relatively easy to perform the heat treatment process in air, in a nitrogen flow, in vacuum, etc.

### SUMMARY OF THE INVENTION

The present invention is contrived to solve the above problems, and it is the object of the present invention to provide a composite magnetic material having excellent magnetic characteristics and a manufacturing method thereof, without requiring complex processes such as flattening a soft magnetic material or controlling the oxygen concentration and without the equipment cost of a magnetic field applying apparatus, etc.

According to an aspect of the present invention, the composite magnetic material comprises multiple composite magnetic particles having metal magnetic particles and insulating films surrounding the metal magnetic particles, wherein the multiple composite magnetic particles are bonded to each other, and wherein the metal magnetic particles comprise only a metal magnetic material and impurities with the mass ratio to the metal magnetic particle of 120 ppm (120×10⁻⁶) or less. Preferably, the mass ratio of impurities is 30 ppm (30×10⁻⁶) or less.

According to the composite magnetic material having the above construction, since the concentration of the impurities in the metal magnetic particles is 120 ppm or less in the mass ratio to the metal magnetic particles, the coercive force of the metal magnetic particles is reduced, and thus the hysteresis loss can be reduced, so that it is possible to exhibit excellent magnetic characteristics. Here, if the mass ratio is larger than 120 ppm, the hysteresis loss of the metal magnetic particles is increased due to the increase of the coercive force of the metal magnetic particles, so that characteristics required for use in motor cores, etc. are deteriorated. Furthermore, by setting the mass ratio of the impurities at 30 ppm or less, it is possible to obtain characteristics with the same degree as in flat rolled magnetic steel sheets and strips usually used in the technical field of motor cores.

Preferably, the multiple composite magnetic particles are bonded together via an organic matter. Here, it is preferable that the organic matter be thermoplastic resins or non-thermoplastic resins. The non-thermoplastic resin implies a resin which has characteristics similar to thermoplastic resins but which melting point does not exist at a temperature lower than a pyrolytic temperature.

The organic matter functions as a lubricant during pressure molding, so that it is possible to suppress destruction of the coating layer of the composite magnetic material.

By adding at least either a thermoplastic resin or a non-thermoplastic resin, the thermoplastic resin or the non-thermoplastic resin infiltrates into the coating layers destroyed during the heat treatment process for stabilization, so that it is possible to repair destroyed coating layers.

In addition, preferably, the thermoplastic resin is any of thermoplastic polyimide, thermoplastic polyamide, and thermoplastic polyamideimide. Thermoplastic polyimide, thermoplastic polyamide, and thermoplastic polyamideimide are excellent in both mechanical strength and resistivity. More preferably, the non-thermoplastic resin is either completely aromatic polyester or completely aromatic polyimide.

It is also preferable that the composite magnetic material comprise only the multiple composite magnetic particles and inevitable impurities contained in the multiple composite magnetic particles. As a result, since the ratio of the composite magnetic particles in the unit volume of a pressure-molded body is high, it is possible to efficiently obtain a high magnetic flux density in a small external magnetic field. Here, the inevitable impurity indicates the impurity which can not be removed even when performing an impurity removing process well-known in the art.

According to another aspect of the present invention, the method of manufacturing a composite magnetic material is provided, which comprises multiple composite magnetic particles having metal magnetic particles and insulating films surrounding the surfaces of the metal magnetic particles. The manufacturing method comprises the following steps: processing the metal magnetic particles to have impurities of the mass ratio to the metal magnetic particles of 120 ppm or less; producing composite magnetic particles by coating the surfaces of the metal magnetic particles with insulating films; and forming the multiple composite magnetic particles by bonding the composite magnetic particles to each other.

A process of decreasing said impurity concentration may include a process of decreasing the impurity concentration, for example, by performing a reduction process to Fe powders at a temperature of 800° C. or higher in an atmosphere of H₂.

As described above, according to the present invention, it is possible to provide a composite magnetic material having desired magnetic characteristics and a manufacturing method thereof.

### BRIEF DESCRIPTION OF THE DRAWING

FIGURE is a graph illustrating the relationship between the impurity concentration of metal magnetic particles and the coercive force in the composite magnetic material according to the present invention.

### DETAILED DESCRIPTION OF THE INVENTION

Pure iron powders used for a composite magnetic material according to the present invention are obtained by melting electrolyzed iron in an inert gas or vacuum and gas-atomizing the melted iron in an inert gas to decrease impurity concentration. Alternatively, the pure iron powders may be obtained by removing carbon added to melted iron or performing a reduction process to manufactured atomized powders, for example, at a temperature of 800° C. or higher in H₂ to decrease the impurity concentration during the process of water-atomizing or gas-atomizing the melted iron. Electrolytic iron described here is defined to be the iron obtained by depositing iron ions on a cathode using an iron anode in a metallurgically electrolytic refining method, the purity of which is 99.99 percent or higher. Then, by processing the pure iron powders obtained in this manner with phosphoric acid and by pressure molding the processed pure iron powders, the composite magnetic material according to the present invention can be obtained. Preferably, the composite magnetic material according to the present invention may be obtained by further performing the stabilization process to the pressure-molded body obtained through the pressure molding. Embodiments of the composite magnetic material and the manufacturing method thereof according to the present invention will be described hereinafter.

First, the surfaces of metal magnetic particles having soft magnetic characteristics, i.e. coercive force thereof of 1 Oe (Oersted) or less and a saturated magnetic flux density of 1.0 T (Tesla) or more, are coated with insulating films, thereby obtaining composite magnetic particles. At that time, the impurity concentration is adjusted so that its mass ratio to the metal material in the metal magnetic particles is 120 ppm or less. It is preferable that the mass ratio be 30 ppm or less. By setting the mass ratio to 30 ppm or less, the composite magnetic material having the same characteristics as flat rolled magnetic steel sheets and strips can be obtained. A mixing method is not specifically limited, but a mixing method such as a mechanical alloying method or a mechano-fusion method may be used in addition to a ball mill method.

Materials having a high saturated magnetic flux density and high magnetic permeability such as iron (Fe), iron-silicon-based (Fe—Si) alloy, iron-nitrogen-based (Fe—N) alloy, iron-nickel-based (Fe—Ni) alloy, iron-carbon-based (Fe—C) alloy, iron-boron-based (Fe—B) alloy, iron-cobalt-based (Fe—Co) alloy, iron-phosphorous-based (Fe—P) alloy, iron-aluminum-based (Fe—Al) alloy, or iron-nickel-cobalt-based (Fe—Ni—Co) alloy may be used as metal magnetic materials of the metal magnetic particles.

It is preferable that an average diameter of the metal magnetic particles ranges from 5 μm to 200 μm. Setting the average diameter of the metal magnetic particles to 5 μm or more makes oxidation of the metal magnetic particles difficult as compared to the case where the metal magnetic particles have a smaller average diameter, and thus inhibits deterioration of the magnetic characteristics thereof. Further, by setting the average diameter of metal magnetic particles to 200 μm or less, it is possible to increase the density of a pressure-molded body without deteriorating the compressibility during pressure molding. Furthermore, the diameters of metal magnetic particles are measured with a sieving method, and thus the particle diameter (50% particle diameter D), at which the sum of masses of metal magnetic particles starting from the smallest diameter side reaches 50% of the total measured mass of metal magnetic particles, is defined to be the average diameter of metal magnetic particles.

The impurity concentration of the metal magnetic particles can be obtained as follows. That is, JISG1211 (infrared absorption method after combustion) is used for C, JISG1212 (molybdosilicic acid blue spectrophotometry) is used for Si, JISG1258 (inductively coupled plasma atomic emission spectrometry) is used for Mn, JISG1214 (molybdophosphoric acid blue spectrophotometry) is used for P, JISZ2616 (infrared absorption method) is used for S, JISG1258 (inductively coupled plasma atomic emission spectrometry) is used for Cu, JISG1258 (inductively coupled plasma atomic emission spectrometry) is used for Ni, JISG1257 (atomic absorption spectrophotometry) is used for Cr, JISZ2613 (infrared absorption method) is used for O, JISG1257 (atomic absorption spectrophotometry) is used for Al, JISG1257 (atomic absorption spectrophotometry) is used for Cu, JISG1257 (atomic absorption spectrophotometry) is used for Mg, and JISG1218 (calorimetric method using thiocyanate) is used for Mo.

Further, in the composite soft magnetic material according to the present invention, insulating films surrounding the surfaces of the metal magnetic particles are formed. The insulating films function as insulating layers, and thereby suppress eddy current loss. The insulating film can be formed by processing the metal magnetic particles with phosphoric acid. It is also preferable that the insulating film contains oxides as desired. Oxide insulators such as manganese phosphate, zinc phosphate, calcium phosphate, silicon dioxide, titanium dioxide, aluminum oxide or zirconium oxide may be used as oxides in addition to iron phosphate which is a metal oxide film containing phosphorous and iron.

In the present invention, the above multiple composite magnetic particles may be bonded via an organic matter as desired. In a method of bonding the multiple composite magnetic particles via an organic matter, the organic matter contained in the molded-body is softened by the heat treatment for stabilization, and the organic matter is allowed to infiltrate between the multiple composite magnetic particles, thereby enhancing a bonding force between the particles. Furthermore, the multiple composite magnetic particles may be bonded directly, not via an organic matter. In this case, no material may essentially be interposed between the composite magnetic particles, but inevitable impurities may exist. Examples of inevitable impurities may include elements such as C, H or O, or compounds thereof existing when forming the insulating films on the surfaces of the metal particles in a wet manner. In the bonding of composite magnetic particles without interposing an organic matter, the unevenness of particles engages with each other, thereby causing strong bonding to form the molded-body.

Either thermoplastic resins and non-thermoplastic resins or mixtures thereof may be used as the organic matter.

Completely aromatic polyester, or completely aromatic polyimide, etc. may be used as a non-thermoplastic resin. Thermoplastic polyimide, thermoplastic polyamide, thermoplastic polyamideimide, polyphenylene sulphide, polyamideimide, polyether sulfone, polyether imide, and polyether ether ketone, etc. may be used as a thermoplastic resin.

It is preferable that the particle diameter of the organic matter range from 0.1 μm to 100 μm. It is more preferable that the particle diameter of the organic matter range from 0.1 μm to 60 μm. As a result, it is possible to further accomplish uniformity in mechanical strength and electrical characteristics.

In addition, preferably, the particle diameter of the organic matter is 1/10 or less of the diameter of the composite magnetic particle. For example, when the average diameter of the composite magnetic particles is 200 μm or less, the average particle diameter of the organic matter is set at 20 μm or less, and when the average diameter of the composite magnetic particles is 150 μm or less, the average particle diameter of the organic matter is set at 15 μm or less. Using the organic matter having the average particle diameter within such a numerical range, facilitates the organic matter particles to infiltrate into gaps between the composite magnetic particles, allowing the organic matter particles in the composite magnetic material to be dispersed further uniformly. As a result, it is possible to further suppress the inhomogeneity of the mechanical strength and insulating property due to non-uniform distribution of the organic matter particles.

Next, mixed powders of the composite magnetic particles and the organic matter particles are put into a metal mold, and the mixed powders are then pressure-molded with a pressure from 390 MPa to 1,500 MPa. As a result, a composite magnetic material in which the mixed powders are pressure-molded is obtained.

In the process of forming the molded-body, by using a wet molding method or a metal mold wetting method, which is a well-known technique, the density and lamination factor of the molded-body are enhanced, thereby obtaining excellent magnetic characteristics. It is preferable that the powder temperature during wet molding be from 100° C. to 180° C.

The pressure molding process may be performed in air, but preferably is performed in an atmosphere of inert gas or decompressed gas. It is advantageous from the viewpoint of production cost that nitrogen gas be used as the inert gas, but argon gas or helium gas may be used.

The composite magnetic material obtained through the pressure molding process is subjected to a heat treatment for stabilization at a temperature equal to or higher than 200° C. and equal to or lower than the pyrolytic temperature of the added resin. As a result, the organic matter is stabilized thinly and uniformly between the composite magnetic particles. The heat treatment for stabilization may be performed in the atmosphere, but preferably is performed in an atmosphere of inert gas or decompressed gas. It is advantageous from the viewpoint of production cost that nitrogen gas be used as the inert gas, but argon gas or helium gas may be used.

### EXAMPLE 1

The soft magnetic material according to the present invention was evaluated by using examples to be described hereinafter.

Iron powders having an average particle diameter of 70 μm were prepared as metal magnetic particles. A reduction process was performed to the iron powders in H₂ at a temperature of 800° C. for 3 hours. At that time, a minute amount of usual iron powders was mixed into the electrolyzed iron so that the impurity concentration of the metal magnetic particles is 1.20×10⁻⁵, 7.60×10⁻⁵, 1.13×10⁻⁴, and 2.07×10⁻⁴. The mixture was melted in vacuum or an atmosphere of inert gas, and then powders were manufactured in an atmosphere of inert gas by using a gas-atomizing method. By processing the respective samples with phosphoric acid, iron powders were then coated with insulating films of phosphate. At that time, the coating process was performed so that the thickness of the insulating films is about 100 nm. Through this coating process, the composite metal magnetic particles in which the surfaces of the iron powders were surrounded with insulating films were formed.

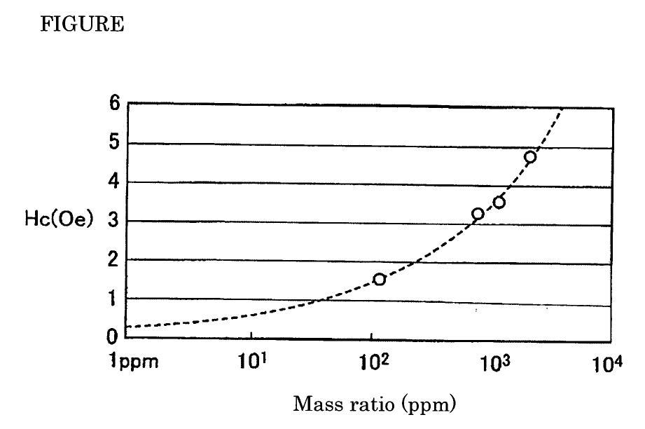

Mixed powders were prepared by mixing the composite metal magnetic particles having the above impurity concentration with polyphenylene sulphide particles (manufactured by DAINIPPON INK Incorporated) having an average particle diameter of 100 μm or less. The mixed powders were put into a metal mold, and were subjected to the pressure molding process. The compressing pressure was set at 882 MPa. As a result, the composite magnetic material samples having the respective impurity concentration were obtained. The composite magnetic material samples having the respective impurity concentration were next subjected to a heat treatment process. The heat treatment process was performed in an atmosphere of nitrogen gas for 1 hour. The coercive force Hc of the composite magnetic material samples having the respective impurity concentration was measured. The results are shown in FIG. 1. FIG. 1 is a graph illustrating the relationship between the impurity concentration of metal magnetic particles and the coercive force in the composite magnetic material according to the present invention. In FIG. 1, the X axis denotes the impurity concentration, and the Y axis denotes the coercive force Hc (Oe).

According to the composite magnetic material of the present invention, it can be seen from FIG. 1 that the coercive force decreases with decreasing the impurity concentration of the metal magnetic particles, so that it is possible to decrease the hysteresis loss.

### EXAMPLE 2

An experiment was performed with the same procedure as in Example 1, except for the impurity concentrations in the metal magnetic particles of 1.87×10⁻⁶, 6.85×10⁻⁶, 1.09×10⁻⁵, 3.06×10⁻⁵, 4.00×10⁻⁵, 1.12×10⁻⁴, 2.33×10⁻⁴, 4.12×10⁻⁴, and 6.55×10⁻⁴. The result of the experiment is shown in the Table.

TABLE

| | Hysteresis loss |
|---|---|
| Impurity concentration | Hc(Oe) |
| 1.87 × 10⁻⁶ | 0.3 |
| 6.85 × 10⁻⁶ | 0.5 |
| 1.09 × 10⁻⁵ | 0.6 |
| 3.06 × 10⁻⁵ | 0.9 |
| 4.00 × 10⁻⁵ | 1 |
| 1.12 × 10⁻⁴ | 1.5 |
| 2.33 × 10⁻⁴ | 2 |
| 4.12 × 10⁻⁴ | 2.5 |
| 6.55 × 10⁻⁴ | 3 |

As can be seen from the results of the Table, with decreasing the impurity concentration in metal magnetic particles, the hysteresis loss decreases exponentially, so that it is possible to obtain the composite magnetic material having excellent magnetic characteristics.

It should be considered that the embodiments and the examples disclosed herein are provided as examples and thus do not limit the present invention. A scope of the present invention is defined by the appended claims, not by the above descriptions, and it is intended that all modifications within the meaning and the range equivalent to the claims are included in the scope of the present invention.

What is claimed is:

1. A composite magnetic material comprising multiple composite magnetic particles having metal magnetic particles and insulating films surrounding the surface of the metal magnetic particles,
wherein the multiple composite magnetic particles are bonded to each other, and
wherein the metal magnetic particles comprise only metal magnetic materials and impurities with the mass ratio to the metal magnetic particle of 120 ppm or less.

2. The composite magnetic material according to claim 1, wherein the mass ratio of the impurities is 30 ppm or less.

3. The composite magnetic material according to claim 1, wherein the multiple composite magnetic particles are bonded together via an organic matter.

4. The composite magnetic material according to claim 1, comprising only the multiple composite magnetic particles and inevitable impurities contained in the composite magnetic particles.

5. A method of manufacturing the composite magnetic material, which comprises multiple composite magnetic particles having metal magnetic particles and insulating films surrounding the surfaces of the metal magnetic particles. The method comprises the following steps:
processing the metal magnetic particles to have impurities with the mass ratio to the metal magnetic particles of 120 ppm or less;
forming composite magnetic particles by coating the surfaces of the metal magnetic particles with insulating films; and
forming the multiple composite magnetic particles by bonding the composite magnetic particles to each other.
